(19) United States
(12) Patent Application Publication
(10) Pub. No.: US 2011/0041667 A1
(43) Pub. Date: Feb. 24, 2011

(54) Mechanism for adjusting blade height of bench saw

(76) Inventor: Pei-Fang Chiang, Changhua (TW)

Correspondence Address: SAM CHEN, 7F-1, 293, ROOSEVELT ROAD, SEC 3, TAIPEI, TW

(21) Appl. No.: 12/545,052

(22) Filed: Aug. 20, 2009

(51) Int. Cl. B23D 45/06; B27B 5/24

(52) U.S. Cl. 83/477.1

(57) ABSTRACT

A bench saw includes a table on a support frame; a hand turning unit comprising a handwheel and a shaft including a threaded end; a transmission unit comprising a frame including a lower slot on either side surface, two T-shaped members pivotably secured to both side surfaces of the frame respectively, each T-shaped member including a transverse first groove and a longitudinal second groove, and a bar including a protrusion at either end, the protrusions being slidingly disposed in the second grooves, and a central threaded hole secured to the threaded end; a blade height adjusting unit comprising a block member secured to the frame, and a grooved sliding member with the block member disposed therein, the sliding member including a guide pin on either side, the guide pins being slidingly disposed in the first grooves; and a saw assembly secured to the sliding member.

### BACKGROUND OF THE INVENTION

1. Field of Invention

The invention relates to bench saws and more particularly to a mechanism for adjusting blade height of a bench saw with improved characteristics.

2. Description of Related Art

A conventional bench saw 10 is shown in FIG. 1 and comprises a support frame 11, a table 12 threadedly mounted on the support frame 11, a saw assembly including a seat 14 and a circular saw blade 13 mounted to the seat 14, a blade height adjusting mechanism (not shown) mounted on one side of the support frame 11 and including a rod 19 mounted in an arcuate slot 113 of a plate (not numbered) and adapted to move along the slot 113 to adjust the height of the saw blade 13, and a blade tilting mechanism (not numbered) including gears 18 attached to the seat 14, a drive shaft 17 rotatably attached to the gears 18, and a handwheel 16 mounted externally of the support frame 11 and adapted to manually rotate the handwheel 16 for tilting both the seat 14 and the saw blade 13.

However, both the blade height adjusting mechanism and the blade tilting mechanisms are typically relatively complex in constructions, costly to manufacture, trouble-prone, and unreliable in use.

There have been numerous suggestions in prior patents for bench saw. For example, U.S. Pat. No. 3,841,188 discloses a bench saw. Thus, continuing improvements in the exploitation of bench saw are constantly being sought.

### SUMMARY OF THE INVENTION

It is therefore one object of the invention to provide a mechanism for adjusting blade height of a bench saw.

The above and other objects, features and advantages of the invention will become apparent from the following detailed description taken with the accompanying drawings.

### BRIEF DESCRIPTION OF THE DRAWINGS

FIG. 1 is a schematic cross-sectional view of a conventional bench saw;

FIG. 2 is an exploded perspective view of a preferred embodiment of bench saw according to the invention;

FIG. 3 is a perspective view of the bench saw of FIG. 1 but in which the support frame has been removed to expose the underlying components when viewing from below the table;

FIG. 4 is a broken-away perspective view of the handwheel and adjacent components including the rotational disc with the steel ball being lockingly disposed in the groove after pushing the handwheel for blade tilting adjustment;

FIG. 5 is an exploded view of the adjustment assembly;

FIG. 6 is a cross-sectional view taken along line 6-6 of FIG. 2;

FIGS. 7 and 8 schematically depict operations before and after a blade height adjustment respectively; and

FIGS. 9 and 10 schematically depict operations before and after a blade tilting adjustment respectively.

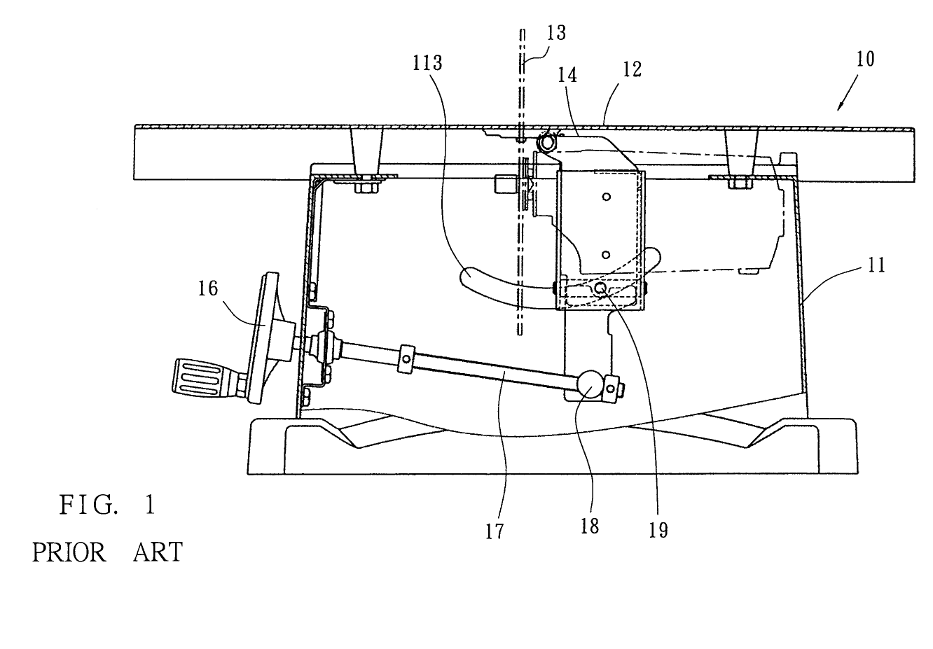

### DETAILED DESCRIPTION OF THE INVENTION

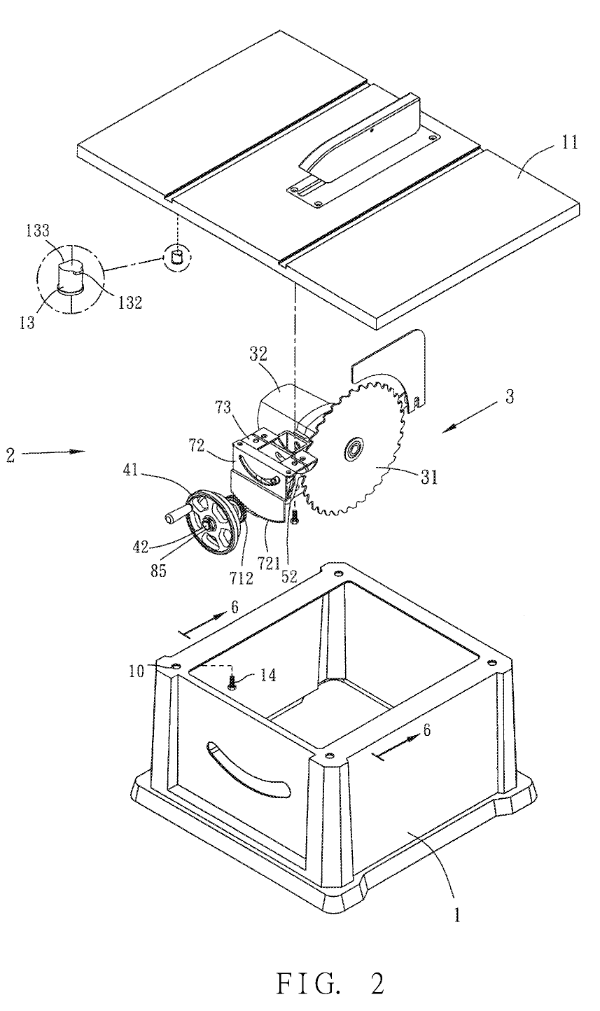

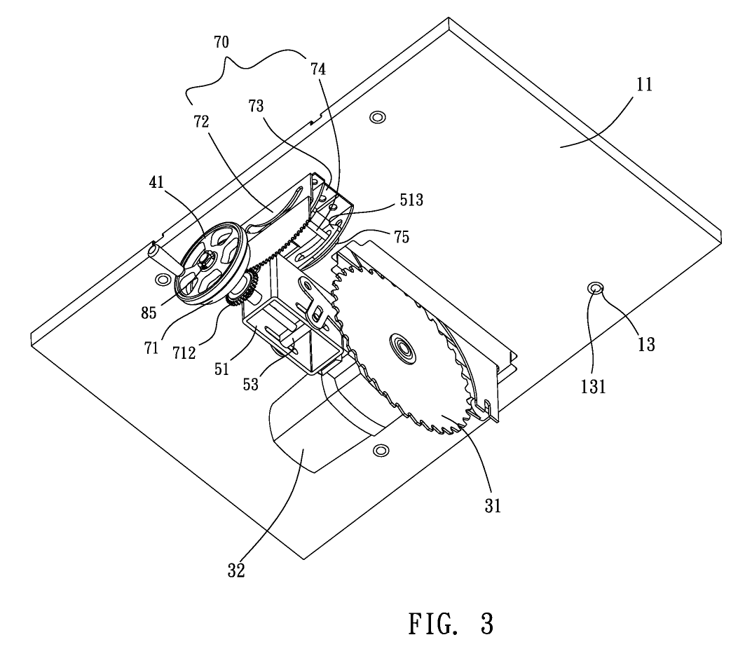

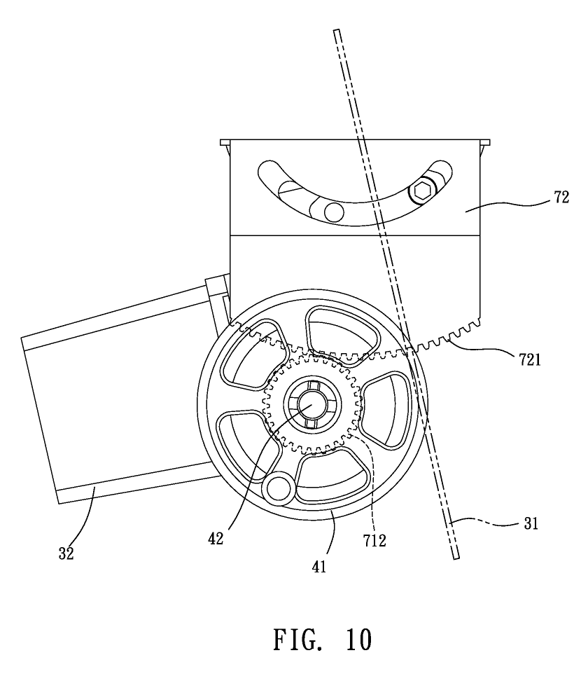

Referring to FIGS. 2 and 10, a bench saw in accordance with a preferred embodiment of the invention comprises the following components as discussed in detail below.

A support frame 1 of square cross section is provided. A rectangular table 11 is made of stone and is threadedly mounted on the support frame 1 as detailed below. Four holes 12 of T-section are provided on the underside of the table 11 and are arranged as four corners of a square respectively. Four short cylindrical pegs 13 each comprises an axial threaded hole 131, a projection 132 on a top edge, and a flat 133 cut on a circumferential surface of the peg 13 opposite the projection 132. The peg 13 is adapted to fit into the complementary hole 12 and is fastened therein by applying adhesive in a space defined between itself and the hole 12. Four screws 14 each is driven into one of four holes 10 on four top corners of the support frame 1 and the threaded hole 131 to fasten the support frame 1 and the table 11 together.

An adjustment assembly 2 comprises a hand turning unit 40, a transmission unit 50, a blade height adjusting unit 60, and a blade tilting unit 70. The hand turning unit 40 comprises a handwheel 41 and a shaft 42. The handwheel 41 comprises a handle 411 projecting out of a peripheral edge, an axial hole 412, a cross-shaped recess 413 in a circular raised portion of an inner surface around the axial hole 412, and a threaded hole 414 on the circular raised portion of the inner surface being in communication with the recess 413.

A steel ball (i.e., detent) 81 in the threaded hole 414 is rotatably urged against the shaft 42 by driving a screw 83 into the threaded hole 414 to compress a helical spring 82 which in turn urges against the steel ball 81 when the handwheel 41 is not pushed. An annular groove 422 is formed on the shaft 42 proximate the steel ball 81.

One end (i.e., outer end) of the shaft 42 is secured to the handwheel 41 by means of a lock pin 85 and the other end (i.e., inner end) thereof is formed as a threaded section 421. A torsion spring 84 is put on the shaft 42 spaced from both ends of the shaft 42.

The transmission unit 50 comprises a rectangular frame 51 including a lower slot 511 on either side surface, an upper hole 512 on either side surface, and two top parallel brackets 513 above the upper holes 512 extending out of the surface, each bracket 513 having an arcuate slot 514 formed therein; two substantially T-shaped members 52 including a through hole 521 at one end of a transverse part, an elongated first slot 523 at the other end of the transverse part, and an elongated second slot 522 at a longitudinal part; a bar 53 including a cylindrical protrusion 531 at either end, the protrusions 531 being slidingly disposed in the second slots 522, and a threaded hole 532 in a central portion with the threaded section 421 of the shaft 42 threadedly fastened therein; and an elongated rod 54 disposed through the through hole 521 of one T-shaped member 52, the upper holes 512, and the through hole 521 of the other T-shaped member 52 in which the T-shaped members 52 are adapted to rotate about the rod 54.

The blade height adjusting unit 60 comprises a dovetail member 62 fixedly secured to one side of the frame 51 and a dovetail slot shaped sliding member 61 including two guide pins 611 on both sides slidingly disposed in the first slots 523, and a longitudinal groove 612 being shaped in conformity to the dovetail member 62 so that the sliding member 61 may slide up or down a predetermined distance relative to the dovetail member 62.

A saw assembly 3 is secured to the sliding member 61 and comprises a high speed motor 32 and a saw blade 31 rotatably driven by the motor 32. The blade tilting unit 70 comprises a rotational disc 71 including a cross-shaped raised member 711 on one surface aligned with and spaced from the complementary recess 413 with the spring 84 compressed therebetween, and a toothed wheel 712 spaced from the other surface; a plate member 72 secured to the underside of the table 11 and including a bottom toothed section 721 meshed with the toothed wheel 712, and an upper arcuate slot 722; two coupling members 73 secured to the underside of the table 11 with the frame 51 disposed therebetween, the coupling member 73 having an arcuate slot 731; two positioning members 75 each fitted onto the slot 731; a sleeve 76; and a pin 74 driven through the sleeve 76, one positioning member 75, one slot 731, one slot 514, the other slot 514, the other slot 731, and the other positioning member 75 to secure them together. The shaft 42 is disposed through the axial hole 412, the recess 413, the raised member 711, the toothed wheel 712, and one side of the frame 51 with its threaded section 421 threadedly secured to the threaded hole 532. Note that a rotation of the shaft 42 will not rotate the rotational disc 71 and vice versa. The assembly of the bench saw is thus complete.

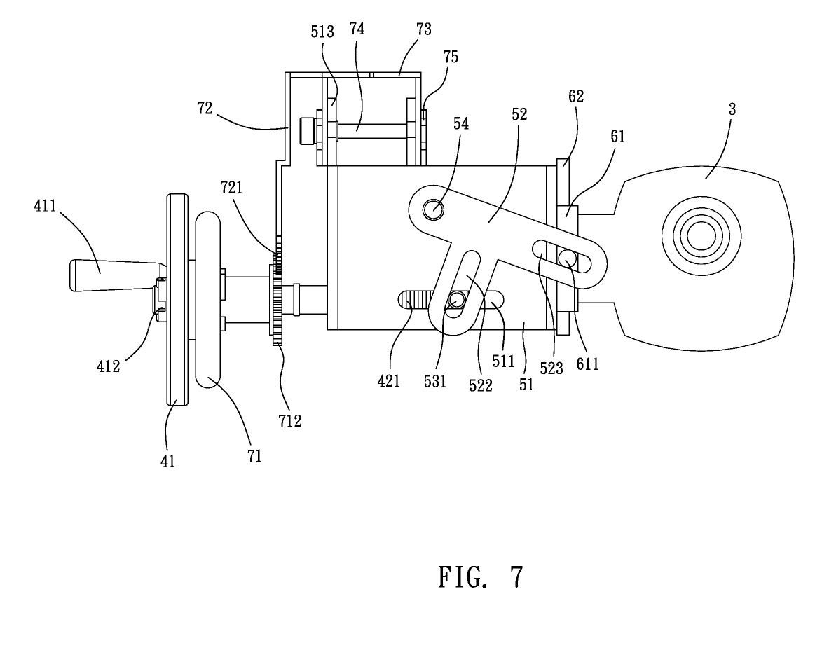

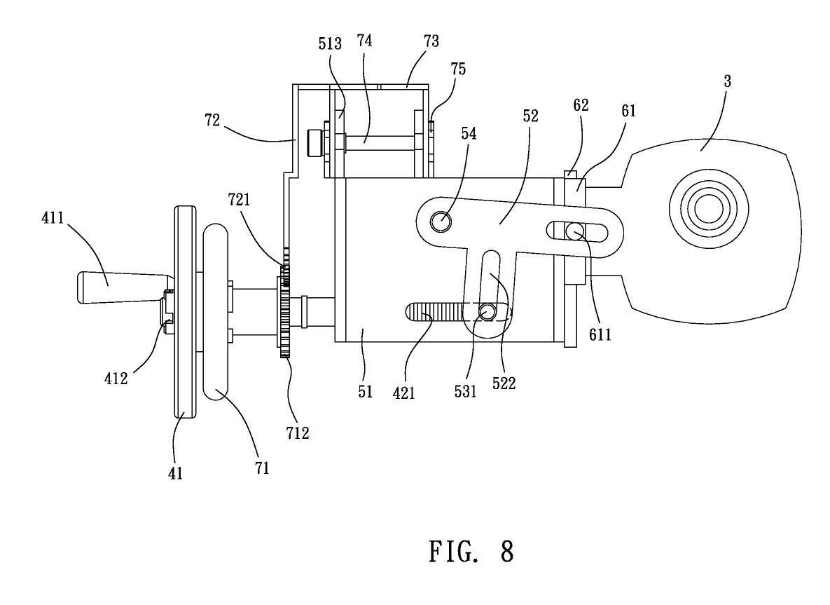

A blade height adjustment operation of the invention will be described in detail by referring to FIGS. 7 and 8 specifically. An employee may turn the handwheel 41 to rotate the shaft 42. Hence, the shaft 42 moves rightward with the protrusions 531 moving rightward also along the slots 511 from the position shown in FIG. 7 to that shown in FIG. 8. At the same time, the T-shaped members 52 pivot counterclockwise about the rod 54 with the sliding member 61 moving upward relative to the dovetail member 62. As a result, the saw assembly 3 moves upward. The saw assembly 3 will remain at its adjusted position once the employee stops turning the handwheel 41.

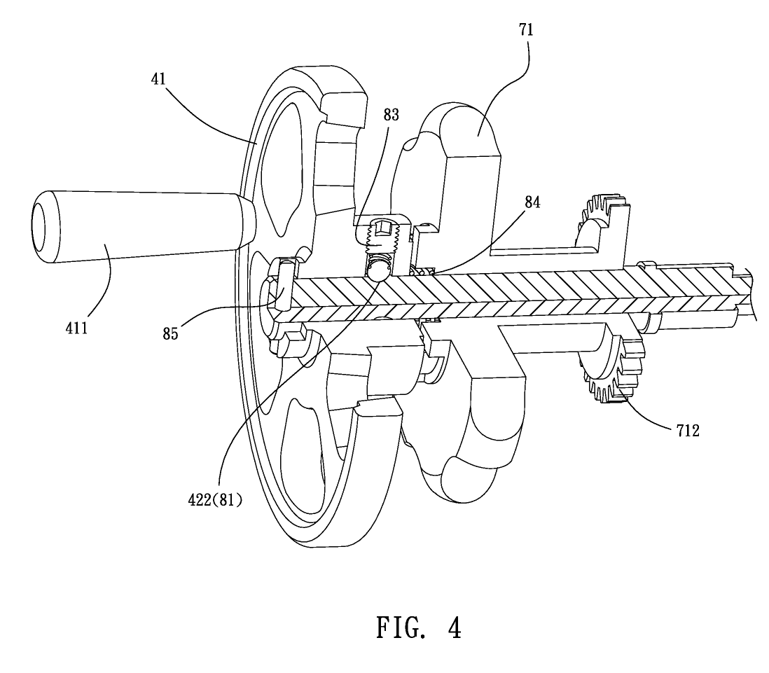

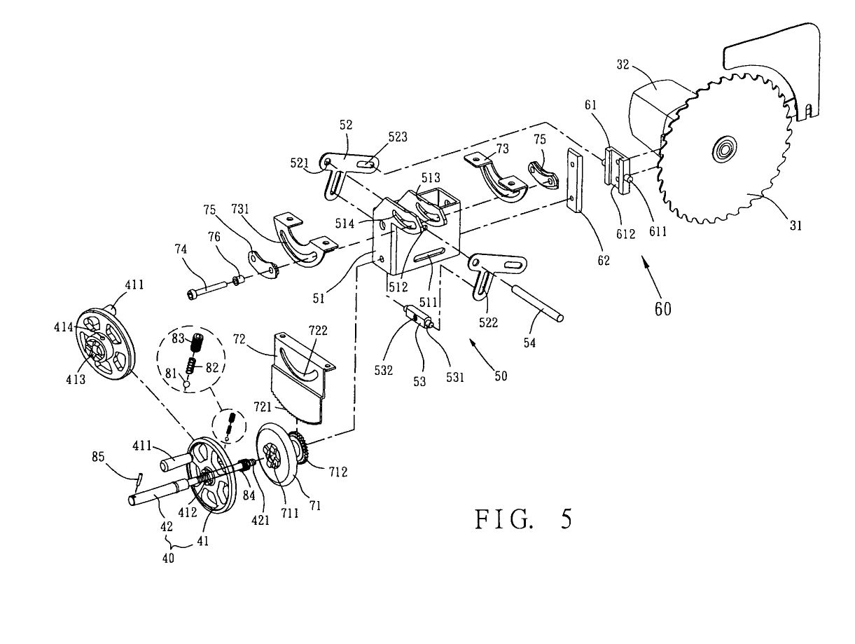

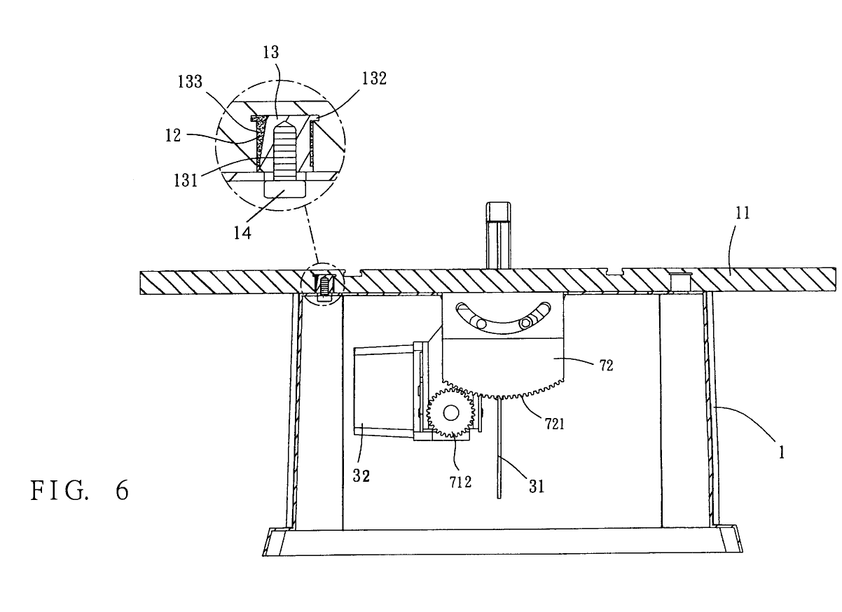

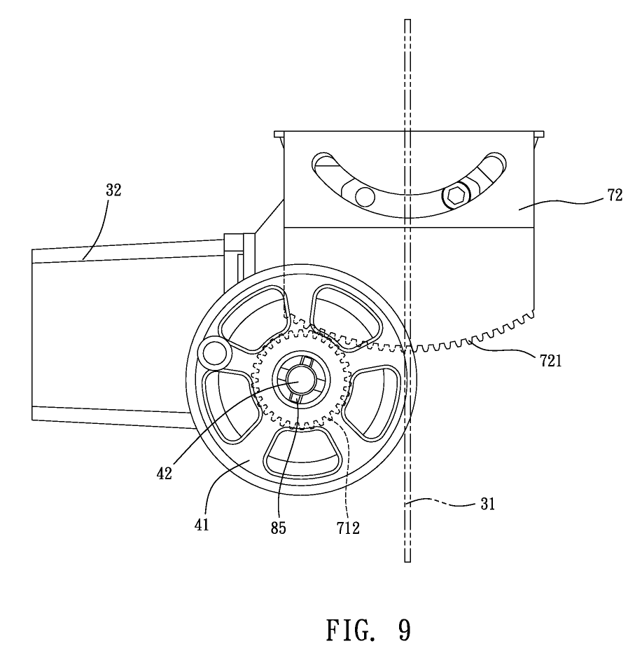

A blade tilting adjustment operation of the invention will be described in detail by referring to FIGS. 4, 9 and 10 specifically. An employee may push the handwheel 41 until the steel ball 81 enters the groove 422 for lockingly positioning due to the automatic expansion of the compressed helical spring 82. At the same time, the spring 84 is compressed and the raised member 711 enters into the recess 413 for temporarily coupling together (i.e., the rotational disc 71 and the handwheel 41 being temporarily coupled together). The toothed wheel 712 thus rides a small distance along the fixed toothed section 721 due to the coupling of the raised member 711 and the recess 413 from the position shown in FIG. 9 to that shown in FIG. 10. That is, the toothed wheel 712 turns to move rightward from the position shown in FIG. 9 to that shown in FIG. 10. As such, both the pivotally moved slot 514 and the pin 74 secured thereto slide rightward along the slot 731 from the position shown in FIG. 9 to that shown in FIG. 10. Thus, the transmission unit 50, the blade height adjusting unit 60, and the saw assembly 3 tilt as a whole. As a result, the saw blade 31 tilts. The saw blade 31 will remain at its tilted position even the employee releases the handwheel 41 because the steel ball 81 is lockingly fastened in the groove 422.

The spring 84 will automatically expand to disengage the raised member 711 from the recess 413 and urge the steel ball 81 against the shaft 42 once the employee slightly pushes the handwheel 41 to cause the steel ball 81 to clear the groove 422 and then immediately releases the handwheel 41 if the employee wants to stop the blade tilting adjustment operation to return to a normal operating state of the bench saw. At the normal operation state, the helical spring 81 is compressed again.

While the invention herein disclosed has been described by means of specific embodiments, numerous modifications and variations could be made thereto by those skilled in the art without departing from the scope and spirit of the invention set forth in the claims.

What is claimed is:

1. A bench saw comprising:
a support frame;
a table releasably mounted on the support frame;
a hand turning unit comprising a handwheel and a shaft disposed through a center of the handwheel, the shaft including a threaded end;
a transmission unit comprising a rectangular frame including a lower slot on either side surface, two substantially T-shaped members pivotably secured to both side surfaces of the frame respectively, each substantially T-shaped member including a first groove at a transverse part and a second groove at a longitudinal part, and a bar including a cylindrical protrusion at either end, the protrusions being slidingly disposed in the second grooves, and a threaded hole in a central portion with the threaded end of the shaft threadedly fastened therein;
a blade height adjusting unit comprising a block member secured to one end surface of the frame, and a grooved sliding member with the block member disposed therein, the sliding member including a guide pin on either side, the guide pins being slidingly disposed in the first grooves; and
a saw assembly secured to the sliding member and comprising a circular saw blade;
whereby turning the handwheel will rotate the shaft to move the protrusions along the second grooves and pivot the substantially T-shaped members so that both the sliding member and the saw assembly may move upward or downward relative to the block member.

2. The bench saw of claim 1, wherein the table is made of stone.

3. The bench saw of claim 1, wherein the handwheel comprises a handle projecting out of a peripheral edge.
